(19) United States
(12) Patent Application Publication
(10) Pub. No.: US 2015/0367518 A1
(43) Pub. Date: Dec. 24, 2015

(54) SYSTEM FOR CONTROLLING POSITION POSE OF ROBOT USING CONTROL OF CENTER OF MASS

(71) Applicant: Korea Institute of Science and Technology, Seoul (KR)

(72) Inventors: Yonghwan OH, Seoul (KR); Dong-hyun LEE, Seoul (KR)

(73) Assignee: Korea Institute of Science and Technology, Seoul (KR)

(21) Appl. No.: 14/735,519

(22) Filed: Jun. 10, 2015

(30) Foreign Application Priority Data
Jun. 20, 2014 (KR) 10-2014-0075738

(51) Int. Cl. B25J 19/00; B25J 9/16

(52) U.S. Cl. CPC B25J 19/0008; B25J 9/1615; B25J 9/1674; Y10S 901/02

(57) ABSTRACT

A control system of a robot keeps an entire posture of a robot not fixed to the ground. The robot includes a body having a plurality of joints and motors mounted to a plurality of limbs and the joints, and the entire posture is maintained by controlling a center of mass (COM) of the robot. The limbs include a robot arm with an end-effector. When a target position of the end-effector (hereinafter, a “target end-effector position”) is input, a target position of the center of mass (hereinafter, a “target COM position”) is calculated using the target end-effector position. The motors mounted to the joints are operated so that the end-effector and the center of mass of the robot move according to the target end-effector position and the target COM position. The target COM position varies in proportion to the change of the target end-effector position.

### CROSS-REFERENCE TO RELATED APPLICATION

This application claims priority to Korean Patent Application No. 10-2014-0075738, filed on Jun. 20, 2014, and all the benefits accruing therefrom under 35 U.S.C. §119, the contents of which in its entirety are herein incorporated by reference.

### BACKGROUND

1. Field

The present disclosure relates to a control system of a robot, and more particularly, to a control system of a robot for controlling a position of a center of mass (COM) of a robot to maintain an entire posture.

2. Description of the Related Art

In a robot such as a humanoid robot which operates without being fixed to the ground, a target value for maintaining an entire posture of the robot is required for the robot to keep its balance. A center of mass is a representative target value.

In order to control a center of mass, position information of the center of mass as well as speed-related information of the center of mass is required, and such information may be obtained by means of center of mass Jacobian.

In case of a target value of an end-effector of a robot which is performing a predetermined operation, definite target values in relation to position and direction are present to process a target work, but it is not easy to set a target value as definite and objective as the center of mass.

In the background art, a center of mass takes an origin point of a robot or an arbitrary position of a user as a target value.

However, the user should correct such setting one by one for each target work, and on occasions, this may give a bad influence on the end-effector of the robot which performs the target work.

In addition, when the robot lifts up a heavy article or the like, a changed position of the center of mass may not be properly reflected, and the robot may easily lose its balance.

### SUMMARY

The present disclosure is directed to providing a control system of a robot, which may control an entire posture of a robot using a center of mass, objectively set, as a target value by reflecting an actual tendency of a changing center of mass of a human.

In one aspect, there is provided a control system of a robot, which keeps an entire posture of a robot not fixed to the ground, wherein the robot includes a body having a plurality of joints and motors mounted to a plurality of limbs and the joints, and the entire posture is maintained by controlling a center of mass (COM) of the robot, wherein the limbs include a robot arm with an end-effector, wherein when a target position of the end-effector (hereinafter, a “target end-effector position”) is input, a target position of the center of mass (hereinafter, a “target COM position”) is calculated using the target end-effector position, wherein the motors mounted to the joints are operated so that the end-effector and the center of mass of the robot move according to the target end-effector position and the target COM position, and wherein the target COM position varies in proportion to the change of the target end-effector position.

In an embodiment, the body may stand in a vertical direction with respect to the ground and be coupled to a support placed on the ground, and the target COM position may have a limited boundary so as not to exceed a radius of the support.

In an embodiment, the target end-effector position may be a distance from any origin point to the end-effector, and the target COM position may be a distance from the origin point to the center of mass.

In an embodiment, when a mass is applied to the end-effector of the robot arm by coupling an object to the end-effector of the robot, the target COM position may be calculated to be moved toward the origin point by a predetermined distance by reflecting a change of the entire center of mass of the robot and the object according to the applied mass.

In an embodiment, the robot may be a humanoid robot which has two robot arms at both sides of the body.

In an embodiment, the target COM position and the target end-effector position may be distances from the origin point in a direction parallel to the ground.

In an embodiment, a mass may be applied to the end-effector of the robot arm by means of an object lifted up by using the end-effector, and the target end-effector position may be a distance from the origin point to the object.

### BRIEF DESCRIPTION OF THE DRAWINGS

FIG. 1 is a schematic view showing a robot according to an embodiment of the present disclosure.

FIGS. 2 and 3 are diagrams showing that a target object is grasped by the robot of FIG. 1.

FIG. 4 is a diagram for conceptually illustrating a process of acquiring data about an actual motion of a human.

FIGS. 5A-5D are diagrams showing collected data about an actual motion of a human.

FIGS. 6A and 6B are diagrams showing a total change of a center of mass (COM) according to a mass and distance of a target object.

FIG. 7 is a graph showing a tendency of a target COM position calculated using a COM positioning unit according to an embodiment of the present disclosure.

FIG. 8 is a graph showing a characteristic of a target COM position calculated by a COM positioning unit according to an embodiment of the present disclosure.

FIG. 9 is a block diagram showing a control system of a robot according to an embodiment of the present disclosure.

### DETAILED DESCRIPTION

Hereinafter, embodiments of the present disclosure will be described with reference to the accompanying drawings. Even though the present disclosure is described based on the embodiments depicted in the drawings, the technical spirit and the essential configurations and operations of the present disclosure are not limited thereto.

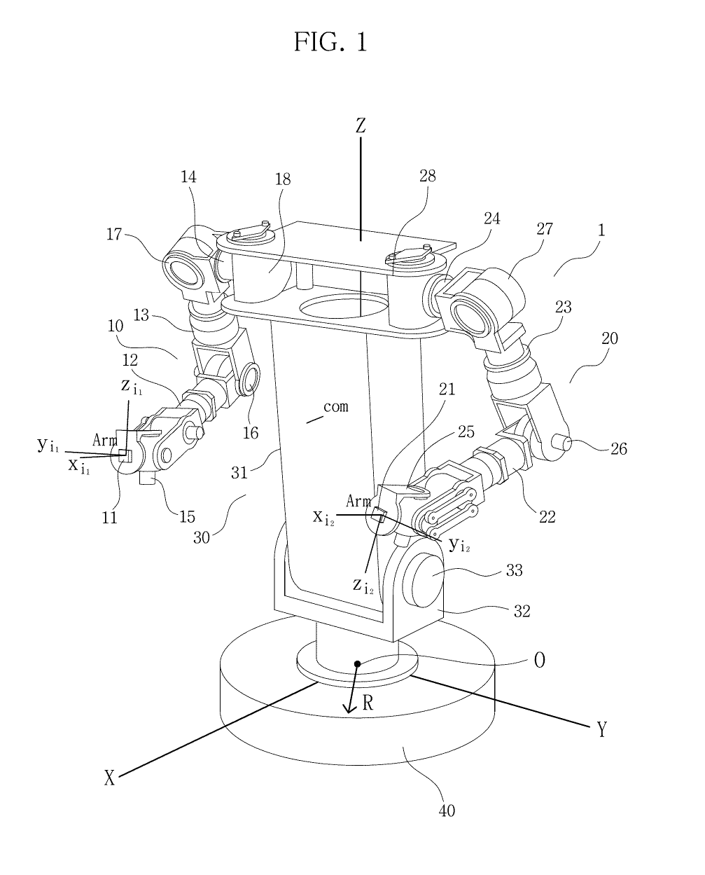

FIG. 1 is a schematic view showing a robot 1 according to an embodiment of the present disclosure.

A robot 1 includes a support 40 placed on the ground, a body 30 substantially vertically coupled on the support 40 and limbs fixed to the body 30. In this embodiment, the limbs are robot arms 10, 20 provided at both sides of the body 30.

The robot 1 of this embodiment is a humanoid robot having a human-like physical structure.

In FIG. 1, x-y-z axes define a space where the robot 1 is located, and an origin point O of the x-y-z absolute coordinate system is set at the center of the upper surface of the support 40.

The support 40 has a cylindrical shape and is not fixed to the ground. Therefore, if the robot 1 fails to control its posture, the robot 1 may fall down without standing properly. The support 40 has a predetermined radius R.

The body 30 is coupled onto the cylindrical support 40 and is classified into an upper body 31 and a lower body 32 based on a joint 33.

Since the upper body 31 is pivotal on the joint 33 in an x-axis direction with respect to the lower body 32 and both the upper body 31 and the lower body 32 are pivotal based on the z-axis, the body 30 has two degrees of operation freedom.

In this embodiment, the body 30 has a single joint 33, but the body 30 may also include a plurality of joints.

Both robot arms 10, 20 have the same structure and respectively include shoulders 14, 24 connected to the body 30, upper arms 13, 23 connected to the joints of the shoulders 14, 24, lower arms 12, 22 connected to the joints of the upper arms 13, 23, end-effectors 11, 21 connected to the joints of the lower arms 12, 22.

The shoulders 14, 24 are connected to the body 30 by means of first joints 18, 28, are pivotal along a rotary shaft extending in the z-axis direction, and are rotatable based on the longitudinal shafts of the shoulders 14, 24, thereby having two degrees of operation freedom.

The upper arms 13, 23 are connected to the shoulders 14, 24 by means of second joints 17, 27, are pivotal with respect to the shoulders 14, 24, and are rotatable based on the longitudinal shafts of the upper arms 13, 23, thereby having two degrees of operation freedom.

The lower arms 12, 22 are connected to the upper arms 13, 23 by means of third joints 16, 26, are pivotal with respect to the upper arms 13, 23, and are rotatable based on the longitudinal shafts of the lower arms 12, 22, thereby having two degrees of operation freedom.

The end-effectors 11, 21 are connected to the lower arms 12, 22 by means of fourth joints 15, 25, are pivotal with respect to the lower arms 12, 22, and are rotatable based on the longitudinal shafts of the end-effectors 11, 21, thereby having two degrees of operation freedom.

Therefore, both robot arms 10, 20 respectively have eight degrees of operation freedom.

The robot 1 of this embodiment coordinates and controls a posture by using position values of the end-effectors 11, 21 (natural coordinate systems (xᵢ₁, yᵢ₁, zᵢ₁) and (xᵢ₂, yᵢ₂, zᵢ₂) of the end-effectors and a coordinate value of the origin point on the absolute coordinate system), twelve rotation values (rolling, yawing and pitching) of the end-effectors 11, 21 with respect to the natural coordinate system and the absolute coordinate system, and three coordinate values of the center of mass (COM) of the robot 1 on the absolute coordinate system.

In this embodiment, x, y, z coordinate values on the absolute coordinate system respectively mean distances from the origin point O in the x-axis, y-axis and z-axis directions.

Since the robot 1 has eighteen degrees of operation freedom in total, including two degrees of operation freedom of the body and sixteen degrees of operation freedom of both arms, the robot 1 of this embodiment is a so-called “redundant” robot having greater degrees of operation freedom in comparison to the total 15 input values for operation control.

The robot 1 of this embodiment is a robot manipulator which may lift up a target object with the robot arms 10, 20 by means of whole body coordination and posture control. It is assumed that a mass of the target object T and a position of the target object T with respect to the origin point O are already known.

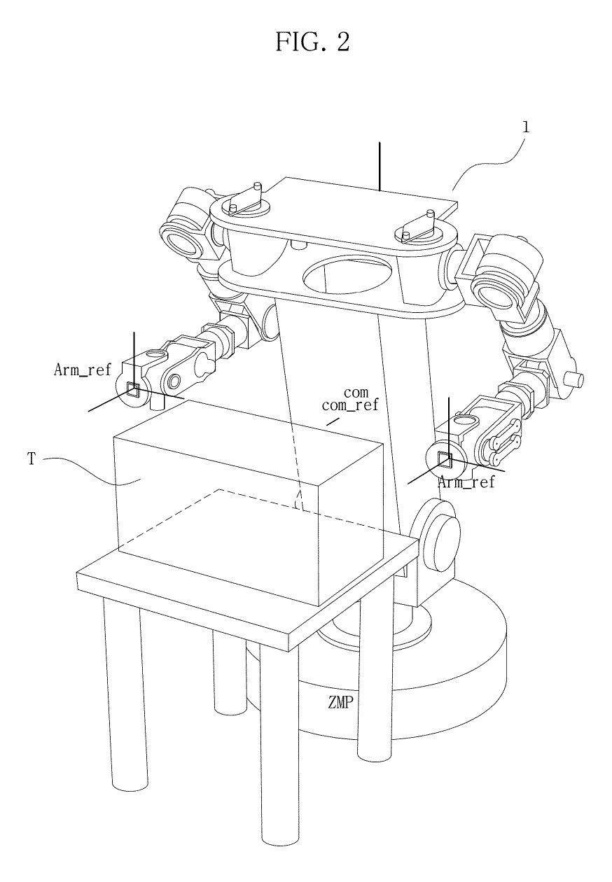

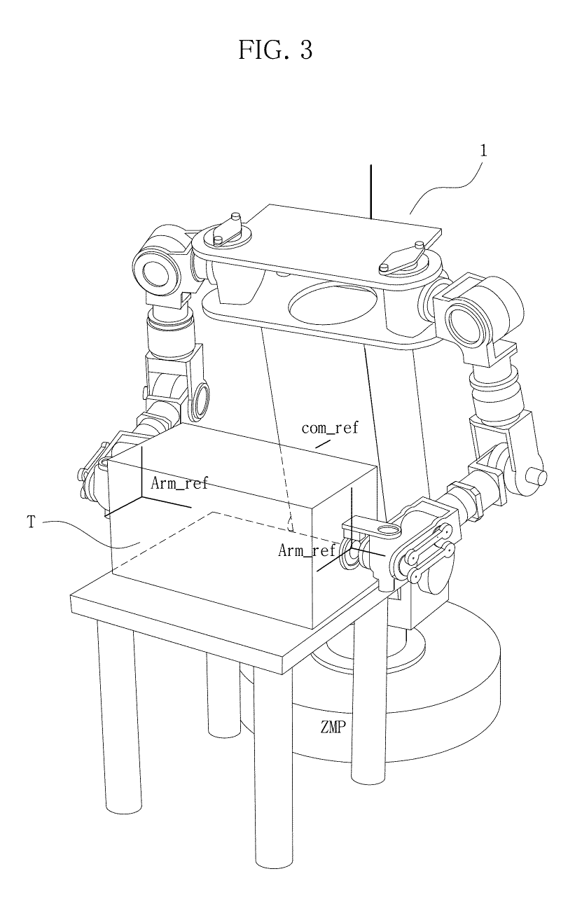

FIGS. 2 and 3 are diagrams showing that a target object T is grasped by the robot 1.

As shown in FIGS. 2 and 3, the robot 1 may lift up the target object T by stretching the robot arms 10, 20 and pressing both sides of the target object T with the end-effectors 11, 21. This is similar to a motion of a human who presses both sides of an object with two hands and lifts up the object.

If the robot 1 stretches the robot arms 10, 20 to lift up and move the target object T or the robot 1 lifts up the target object T and thereby adds a mass, the center of mass (COM) of the robot 1 should be adjusted in order to keep a balance.

Since the support 40 is not fixed to the ground, if the center of mass is not properly controlled, the robot 1 may fall down without maintaining its posture.

In this embodiment, in order to calculate a target position of the center of mass (hereinafter, referred to as a “target COM position”) for controlling a posture of the robot 1, a balance keeping strategy of the robot is inferred with reference to an actual motion of a human.

In this embodiment, in order to infer a balance keeping strategy when the robot 1 stretches the robot arms 10, 20, first, an actual motion of a human who is to lift up and move an object is acquired and analyzed.

In order to acquire an actual motion of a human, an IMU-based motion capture system is used, and data is collected in a state where a target object is located at different heights, while changing a mass of the target object to be grasped.

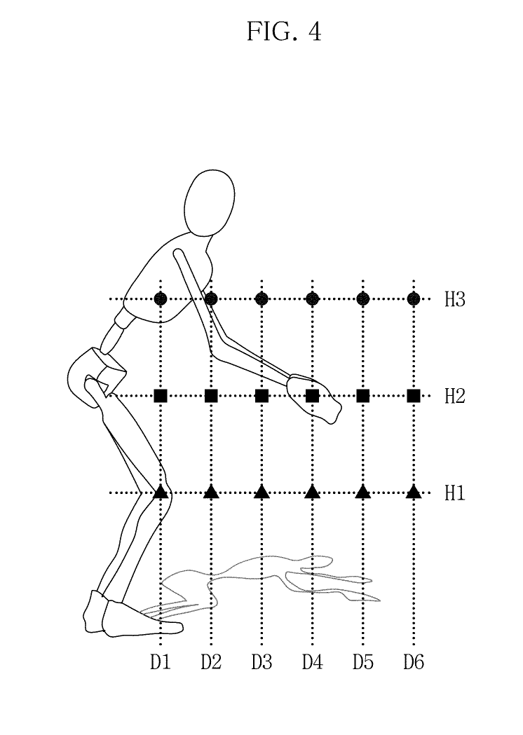

In detail, as shown in FIG. 4, target objects with three kinds of masses are located at six different distances and three heights.

Three males having a mean mass of 65 kg and a mean height of 172 cm perform motions for data acquisition.

The experimenter standing on the ground performs motions of “grasping a target object”, “lifting up the target object to the front of the chest”, “returning the target object to its original position”, and “putting down the target object” (“pick-and-place motion”). The obtained data include an x-directional position, a z-direction position and a mass of the target object. In addition, information of each joint is acquired, and from this, a center of mass (COM) and a zero moment point (ZMP) are obtained.

The dynamic information of the acquired human motion data is analyzed by applying a mid-size anatomic model in which a body has five links and each limb has three links, as proposed in the paper of Armstrong “Anthropometry and Mass Distribution for Human Analogues” (U.S. Army Aeromedical Research Laboratory Report, 1988).

In this embodiment, a 2-D motion on a sagittal plane composed of x and z axes is put into consideration, and a center of mass and a zero moment point of a human with respect to the 2-D motion are calculated and analyzed to find a tendency.

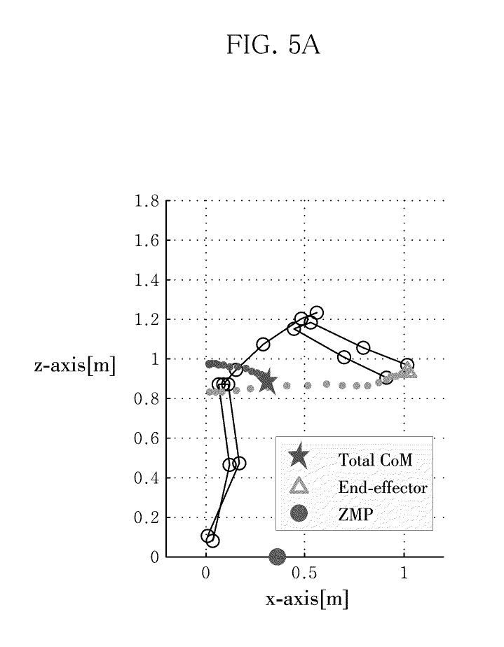

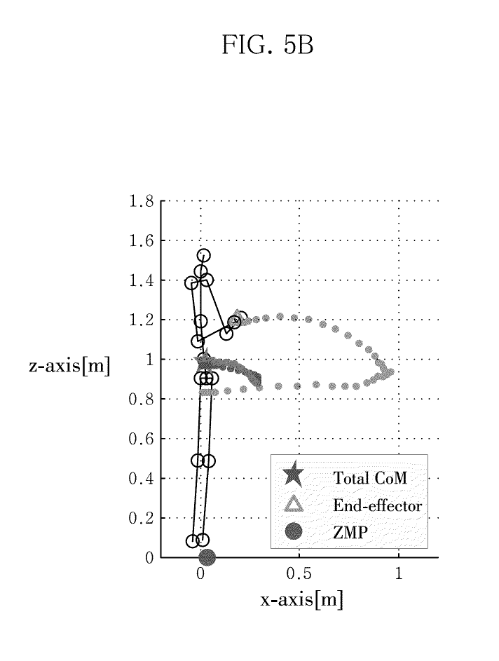

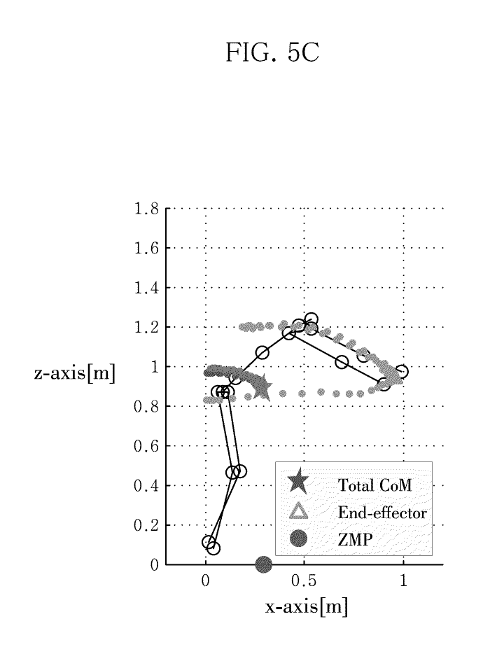

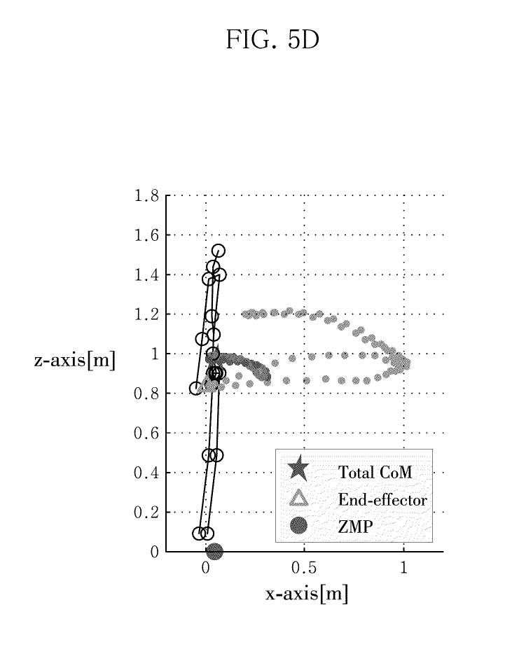

FIGS. 5A to 5D are diagrams showing collected data about an actual motion of a human.

The pick-and-place motion has four phases of 1) from an initial state where hands are dangled down and relaxed, stretching the hands to reach a target object, 2) grasping the target object and lifting up to the front of the chest, 3) moving the target object to its original position and placing down, and 4) returning the body to its initial state. FIGS. 5A to 5D visually depict data acquired in each phase.

In the robot posture control, a major interest is drawn to an instant changing from the phase 1) to the phase 2) and an instant changing from the phase 3) and to the phase 4), at which the hands are stretched to the maximum and thus a balance may be easily lost.

Such an instant when a motion phase is changing is detected from a segmentation process which finds an instant when a moving speed of the hands becomes minimal locally.

A total center of mass of a system composed of a target object and a human body is calculated with regard to each phase changing point. In addition, ZMP which is an important parameter for robot posture control is calculated. The total center of mass, the ZMP and the position of the hand (the end-effector) are depicted in FIGS. 5A to 5D.

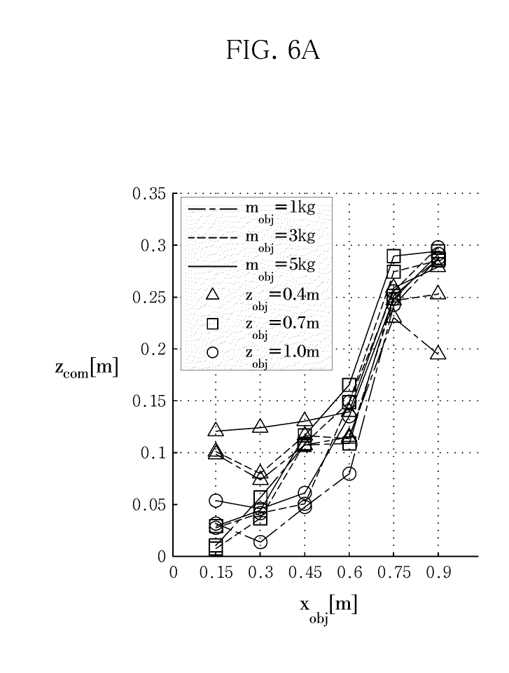

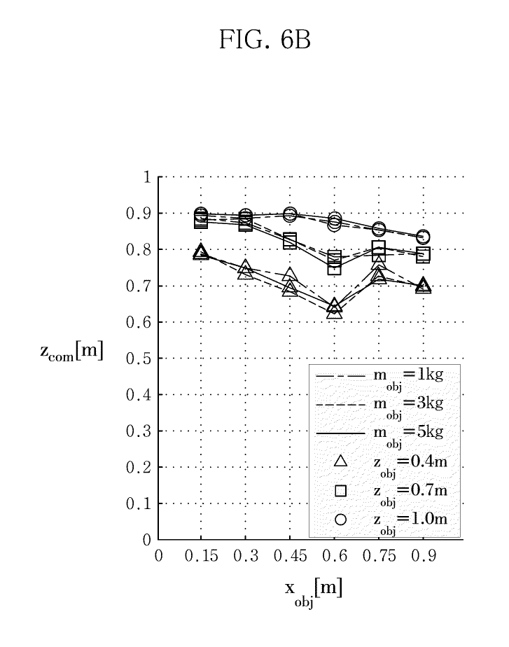

FIGS. 6A and 6B are diagrams showing a total change of a center of mass according to a mass of a target object and a distance from an experimenter.

After analyzing a motion of a human as shown in FIGS. 6A and 6B, it is found that a x-directional position of the total center of mass (COM, x_{com}) has close relation with a x-directional position of the target object (x_{obj}) and has substantially a linear relation (FIG. 6A), but has very low relation with a mass of the target object (m_{obj}) and a z-directional position of the target object (z_{obj}) (FIG. 6B).

Meanwhile, though not shown in the figures, a z-directional position of the total center of mass (COM, z_{com}) has close relation with a z-directional position of the target object (z_{obj}) but has very low relation with a mass of the target object (m_{obj}) and a x-directional position of the target object (x_{obj}).

FIGS. 6A and 6B show that the x-directional position of the total center of mass (COM, x_{com}) is proportional to the x-directional position of the target object (x_{obj}). In a state where the object is not grasped, a total center of mass of the human and the target object is identical to a center of mass of the human. Thus, the above analysis result means that if an end-effector (hands) moves to grasp an object, the center of mass also moves together in the same direction.

However, as shown in FIGS. 6A and 6B, it may be understood that if the x-directional position of the target object (x_{obj}) increases over a certain level, even though the x-directional position of the target object (x_{obj}) increases, the x-directional position of the total center of mass (COM, x_{com}) does not substantially increase but converges to a certain boundary value.

Feet of a human are not fixed to the ground, and thus it may be understood that a human holds a center of mass inside a predetermined support region (for example, a sole region) in order to keep the balance.

In this embodiment, a COM positioning unit for determining a target COM position to control a posture of the humanoid robot 1 with reference to a human motion characteristic is designed.

By using an actual motion characteristic of a human as described above, a total center of mass of a system including a target object and a robot and a position of the target object are derived using Equation 1 below, which has a combination of a linear equation and a reciprocal of a polynomial expression.

$${x}_{obj} = {k}_{1} {x}_{com}^{( t )} + {k}_{2} \frac{- 1}{{x}_{com}^{( t )} - b} \qquad Equation 1$$

Here, x^{(t)}_{com} represents a distance in an x-axis direction from an origin point O of a total center of mass of a system including the robot 1 and the target object T, x_{obj} represents a distance in an x-axis direction from an origin point O of the target object T, k₁ represents a proportional gain of the COM positioning unit, k₂ represents a safety margin from an asymptotic value, and b represents a boundary value of the center of mass.

In the above, it has been described that the x-directional position of the center of mass (COM, x_{com}) has close relation with the x-directional position of the target object (x_{obj}), and the z-directional position of the total center of mass (COM, z_{com}) has close relation with the z-directional position of the target object (z_{obj}).

Equation 1 may also be suitably applied to a relation between the z-directional position of the total center of mass (COM, z_{com}) and the z-directional position of the target object (z_{obj}).

For convenient explanation, hereinafter, a term “position” will be used as indicating a distance in the x-axis direction (namely, in a direction parallel to the ground) from the origin point O.

K₁ which is a scaling factor of the target COM position and the target end-effector position is determined in consideration of a ratio of masses of the robot arms 10, 20 to the total mass of the robot 1.

A boundary value b of the center of mass may be determined by reducing a desired safety margin from the radius R of the support 40.

If the target object is not in a state of being grasped and lifted up, the total center of mass may be identical to the center of mass of the robot.

Therefore, the center of mass of the robot may be expressed as Equation 2 below.

$${x}_{com , d}^{( t )} = \frac{( {x}_{obj} + {k}_{1} b ) - \sqrt{{( {x}_{obj} - {k}_{1} b )}^{2} 4 {k}_{1} {k}_{2}}}{2 {k}_{1}} \qquad Equation 2$$

Here, X^{(r)}_{com, d} represents a target center of mass.

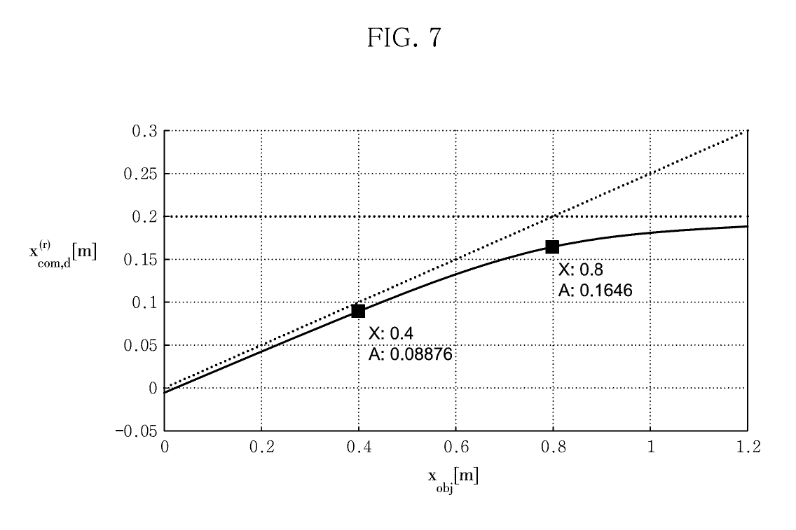

FIG. 7 is a graph of Equation 2.

As shown in FIG. 7, the target COM position of the robot varies in proportion to the change of the position of the target object T. In this embodiment, the position of the target object T is identical to the target position of the end-effectors 11, 21 (hereinafter, “target end-effector position”) for grasping the target object T, and thus the target COM position of the robot may be regarded as varying in proportion to the target end-effector position.

However, if the position value of the target object T increases over a predetermined distance, the target COM position increases only within a limit not exceeding a specific value. In other words, the boundary of the target COM position is limited. FIG. 7 shows a case where the boundary value b of the center of mass is set to be 0.2 m from the origin point O.

The boundary value b of the center of mass is selected by reducing a desired safety margin from the radius R of the support 40, and thus in this embodiment, the boundary of the target COM position is limited not to exceed at least the radius R of the support 40.

Meanwhile, if the robot arms 10, 20 of the robot 1 grasp and lift up the target object T, a mass corresponding to the mass of the target object T is applied to the end-effectors 11, 21, and thus a total center of mass of a system including the robot 1 and the target object T changes in comparison to a case where the object is not grasped.

If a mass is applied to the end-effectors 11, 21 due to a target object or the like, the COM positioning unit of this embodiment calculates the target COM position by reflecting the change of the total center of mass caused by the added mass.

If the mass of the object is put into consideration, a total center of mass (x^{(t)}_{com}, d) is obtained as in Equation 3 below, which may be arranged based on the target center of mass of the robot as in Equation 4 below.

$$\begin{matrix}{x}_{com , d}^{( t )} = \frac{{m}_{robot} {x}_{com , d}^{( r )} + {m}_{obj} {x}_{obj}}{{m}_{robot} + {m}_{obj}} & Equation 3 \\ {x}_{com , d}^{( r )} = \frac{( {m}_{robot} + {m}_{obj} ) {x}_{com , d}^{( t )} - {m}_{obj} {x}_{obj}}{{m}_{robot}} & Equation 4\end{matrix}$$

Here, m_{robot} represents a mass of the robot 1, and m_{obj} represents a mass of the target object T.

If Equation 2 is arranged together with Equation 4, the following Equation 5 may be obtained.

$${x}_{com , d}^{( r )} = \{ \begin{matrix}{x}_{com , d}^{( t )} & ( released ) \\ \frac{( {m}_{rob} + {m}_{obj} ) {x}_{com , d}^{( t )} - {m}_{obj} {x}_{obj}}{{m}_{rob}} & ( grasped )\end{matrix} \qquad Equation 5$$

In Equation 5, the following may be obtained.

$${x}_{com , d}^{( t )} = \frac{( {x}_{obj} + {k}_{1} b ) - \sqrt{{( {x}_{obj} - {k}_{1} b )}^{2} + 4 {k}_{1} {k}_{2}}}{2 {k}_{1}}$$

If the robot 1 operates the robot arms without grasping the target object T (in a released state), the COM positioning unit calculates the target COM position by using the upper equation of Equation 5. If the robot 1 operates the robot arms while grasping the target object T (in a grasped state), the COM positioning unit calculates the target COM position by using the lower equation of Equation 5.

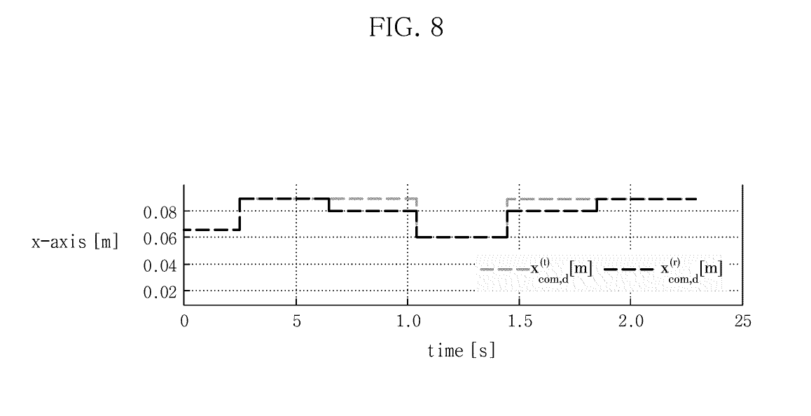

FIG. 8 is a graph showing a characteristic of a target COM position calculated by a COM positioning unit.

The robot 1 is controlled to perform a pick-and-place operation. Here, at about seven seconds after initiating the operation, the robot 1 grasps and lifts up an object, and at about 18 seconds after initiating the operation, the robot 1 places the object at its original position.

As shown in FIG. 8, in a state where the robot does not grasp the object, the target center of mass of the robot is calculated identical to the total center of mass of the system including the robot and the object. However, it may be understood that if the robot grasps the object, the target center of mass of the robot is calculated to be moved toward the origin point O by a predetermined distance.

In this case, even when the robot 1 grasps an object, the robot 1 may control its posture without losing its balance.

In this embodiment, before the COM positioning unit calculates the target COM position, it is possible to determine in advance whether the target object is at a position which can be reached by the end-effector of the robot 1 or whether the input mass of the target object is within a range capable of being lifted up by the robot 1. If an instruction beyond a working radius or load available by the robot 1 is input, the COM positioning unit calculates the target COM position.

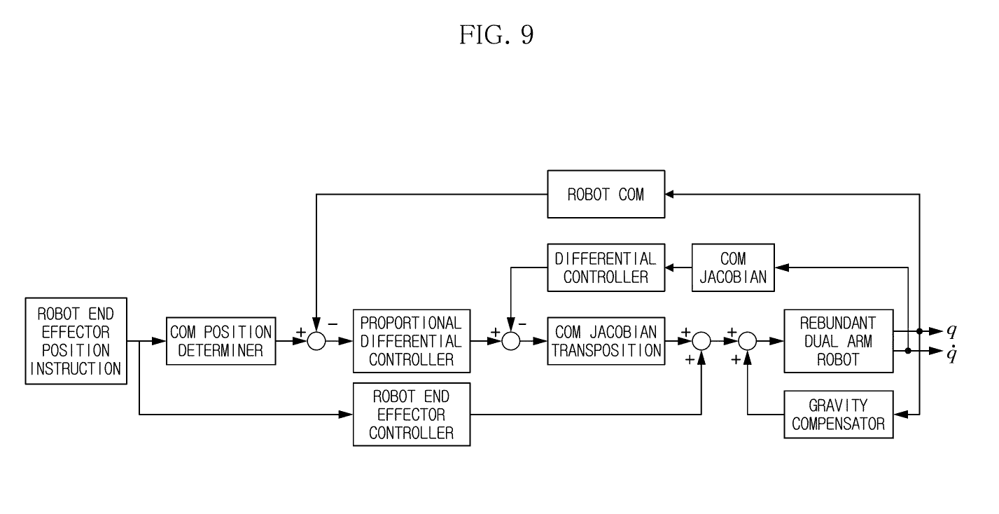

FIG. 9 is a block diagram showing a control system of a robot 1 according to this embodiment.

The control system of the robot 1 includes the COM positioning unit described above.

In the control system of the robot 1 according to this embodiment, positions of the end-effectors 11, 21 are used as input values for work accomplishment and posture control.

If a user indicates positions of the end-effectors 11, 21, the COM positioning unit calculates a target COM position of the robot.

For example, if a user indicates and inputs positions and rotations of the end-effectors 11, 21 in order to perform a pick-and-place operation, a robot end-effector controller measures a position and velocity of a motor provided at each joint of the robot 1 by using encoders attached to the robot arms 10, 20, and calculates a torque of an operator according to the input value input by the user.

The COM positioning unit calculates the target COM position of the robot by using Equation 5 (the position of the end-effector is a position of the target object (x_{obj}) of Equation 5).

By using a current position of the center of mass of the robot 1, COM Jacobian and a proportional-differential controller, a torque of the motor of the joint according to the calculated target COM position is calculated. At this time, a resultant value of the proportional-differential controller is changed into a torque by means of an operation using a COM Jacobian transposed matrix.

In this embodiment, a gravity compensator for compensating a load of the robot arm is provided, and thus the end-effector controller and the gravity compensator are used for controlling the end-effector. Resultant values of the end-effector controller and the gravity compensator are added to the torque of each joint according to the target COM position, and a final torque for controlling the motor of each joint of the robot 1 is calculated.

In more detail, assuming that joint position vectors of the body 30, a left arm 20 and a right arm 10 of the robot 1 are respectively qₒ, q₁, q₂, the joint position vectors of the robot may be expressed as in Equation 6 below.

q=[qₒ^{T}q₁^{T}q₂^{T}]^{T} Equation 6

This may also be expressed as follows.

qₒ₁=[qₒ^{T}q₁^{T}]^{T}, qₒ₂=[qₒ^{T}q₂^{T}]^{T}

Jacobian matrix (Jₒ₁, Jₒ₂) of the end-effector and Jacobian matrix (J_{com}) of the center of mass are obtained as in Equations 7 to 9 below.

$$\begin{matrix}{J}_{01} = \frac{\partial {x}_{end , 1}}{\partial {q}_{01}} = [ \begin{matrix}{J}_{01 , 0} \\ {J}_{01 , 1}\end{matrix} ] -> {J}_{1} = [ \begin{matrix}{J}_{01 , 0} \\ {J}_{01 , 1} \\ {0}_{{n}_{2}} \times 3\end{matrix} ] & Equation 7 \\ {J}_{02} = \frac{\partial {x}_{end , 2}}{\partial {q}_{02}} = [ \begin{matrix}{J}_{02 , 0} \\ {J}_{02 , 2}\end{matrix} ] -> {J}_{2} = [ \begin{matrix}{J}_{02 , 0} \\ {0}_{{n}_{1}} \times 3 \\ {J}_{02 , 2}\end{matrix} ] & Equation 8 \\ {J}_{com} = \frac{\partial {x}_{com}^{( r )}}{\partial q} & Equation 9\end{matrix}$$

Here, nₒ, n₁, n₂ respectively mean the degree of freedom of each part, and (nₒ+n₁+n₂) mean Jacobian augmented by 3 matrixes.

From the above, a torque vector input to the motor of each joint is obtained as in Equation 10 below.

$${u}_{0 i} = - C \dot{q} + {J}_{i}^{T} ( - {c}_{end} {\dot{x}}_{end , i} + {k}_{end} Δ {x}_{end , i} ) + \frac{1}{2} {J}_{com}^{T} ( - {c}_{com} {\dot{x}}_{com}^{( r )} + {k}_{com} Δ {x}_{com}^{( r )} ) + {( - 1 )}^{i} δ [ {i}_{gsp} ] {J}_{i}^{T} {k}_{gsp} \frac{{x}_{end , 1} - {x}_{end , 2}}{‖ {x}_{end , 1} - {x}_{end , 2} ‖} \qquad Equation 10$$

Among the terms in Equation 10, the first term is directed to damping of a joint to enhance safety of the system by means of the gravity compensator, the second and third terms are directed to control inputs about positions of the end-effector and the center of mass, respectively, and the last term is directed to a grasp control input for an i^{th} limb.

In this embodiment, an object and definite target COM position may be calculated using a target end-effector position clearly proposed by a user, and thus it is not needed for the user to correct target COM positions of target works one by one. In addition, since the position of the center of mass is set in association with the position of the end-effector of the robot which performs a target work, it is possible to prevent a target COM position from being arbitrarily set and thus giving a bad influence on the robot end-effector.

Further, since the boundary within which the robot 1 is capable of controlling a posture is put into consideration when setting the target COM position, the target COM position is always set within a range not exceeding an available limit of the center of mass of the robot. Therefore, the robot may keep its posture very stably.

What is claimed is:

1. A control system of a robot, which keeps an entire posture of a robot not fixed to the ground,
wherein the robot includes a body having a plurality of joints and motors mounted to a plurality of limbs and the joints, and the entire posture is maintained by controlling a center of mass (COM) of the robot,
wherein the limbs include a robot arm with an end-effector,
wherein when a target position of the end-effector (hereinafter, a “target end-effector position”) is input, a target position of the center of mass (hereinafter, a “target COM position”) is calculated using the target end-effector position,
wherein the motors mounted to the joints are operated so that the end-effector and the center of mass of the robot move according to the target end-effector position and the target COM position, and
wherein the target COM position varies in proportion to the change of the target end-effector position.

2. The control system of a robot according to claim 1,
wherein the body stands in a vertical direction with respect to the ground and is coupled to a support placed on the ground, and
wherein the target COM position has a limited boundary so as not to exceed a radius of the support.

3. The control system of a robot according to claim 1,
wherein the target end-effector position is a distance from any origin point to the end-effector, and the target COM position is a distance from the origin point to the center of mass.

4. The control system of a robot according to claim 3,
wherein when a mass is applied to the end-effector of the robot arm by coupling an object to the end-effector of the robot, the target COM position is calculated to be moved toward the origin point by a predetermined distance by reflecting a change of the entire center of mass of the robot and the object according to the applied mass.

5. The control system of a robot according to claim 2,
wherein the robot is a humanoid robot which has two robot arms at both sides of the body.

6. The control system of a robot according to claim 3,
wherein the target COM position and the target end-effector position are distances from the origin point in a direction parallel to the ground.

7. The control system of a robot according to claim 3,
wherein a mass is applied to the end-effector of the robot arm by means of an object lifted up by using the end-effector, and
wherein the target end-effector position is a distance from the origin point to the object.
